(19) United States
(12) Patent Application Publication
(10) Pub. No.: US 2026/0125561 A1
(43) Pub. Date: May 7, 2026

(54) EMULSION AND PAVING MATERIAL

(71) Applicant: Honeywell International Inc., Charlotte, NC (US)

(72) Inventors: Yonghong Ruan, Wayne, NJ (US); Guiyang Zhu, Suzhou (CN); Shaomin Chen, Suzhou (CN); Scott M. Hacker, River Edge, NJ (US); Swapnil Kanaujia, Haryana (IN); Anand Shankar S Mahadware, Haryana (IN); Vidya Gupta, Haryana (IN)

(73) Assignee: Honeywell International Inc., Charlotte, NC (US)

(21) Appl. No.: 19/350,079

(22) Filed: Oct. 6, 2025

Related U.S. Application Data
(60) Provisional application No. 63/716,296, filed on Nov. 5, 2024.

(51) Int. Cl. C08L 95/00; C08L 23/06; C08L 25/10

(52) U.S. Cl. CPC C08L 95/005; C08L 23/06; C08L 25/10; C08L 2555/52

(57) ABSTRACT

An emulsion includes water; asphalt; an emulsifier in an amount of from about 0.5 to about 5 wt %, based on a total weight of the emulsion; a polyolefin having a weight average molecular weight (M_{w}) of from about 500 to about 30,000 Da; and a copolymer having at least two repeating units wherein a first repeating unit is a styrene residue, and a second repeating unit is a butadiene residue.

### CROSS-REFERENCE TO RELATED APPLICATION

This application claims the benefit of U.S. Provisional application No. 63/716,296, filed on Nov. 5, 2024, the entire content of which is hereby incorporated by reference.

### TECHNICAL FIELD

The present disclosure generally relates to an emulsion and a paving material. More specifically, this disclosure relates to an emulsion including asphalt, an emulsifier, a particular polyolefin, and a particular copolymer.

### BACKGROUND

Asphalt (bitumen) is commonly used as a paving material for road construction and maintenance. Typically, asphalt, often referred to as “asphalt binder” or “asphalt cement,” is mixed with aggregate to form material used in asphalt paving. Processing and use of this material by paving crews yields asphalt pavement. The asphalt pavement includes aggregate held within a continuous phase of the asphalt binder by adherence of the asphalt binder to the aggregate.

The strength and durability of the asphalt pavement depends on various factors such as the properties of the materials used, the interaction of the various materials, the mix design, construction practices and the environment and traffic conditions to which the pavement is exposed. To produce a mix that will have good performance during the lifetime of the pavement, it is important to attain proper coating of the aggregate with the asphalt with good adhesion of the asphalt onto the aggregate, good cohesive strength of the asphalt, flexibility of the asphalt, and resistance to external conditions, e.g. UV exposure, drastic temperature changes, etc.

Asphalt emulsions have been used worldwide in preventive and corrective maintenance projects on various types of pavement structures, such as highways, expressways, city roads, bus lanes, county roads, airports, etc. In order to obtain better field performance, sometimes various types of polymers are used in asphalt emulsions, e.g., in polymer-modified asphalt emulsions or simply modified asphalt emulsions.

During the production stage, most specifications for polymer-modified asphalt emulsions include elastic recovery, softening point, viscosity, stability, etc. During application, there are additional requirements such as chip retention, rutting resistance, abrasion resistance, UV light stability, etc. Elastomer-modified asphalt emulsions can provide elastic recovery but generally have high viscosity, low softening point, low chip retention, and poor UV light stability. On the other hand, plastomer-modified asphalt emulsions have low viscosity, high softening point, high chip retention, and good UV light stability, etc., but minimal elastic recovery.

Accordingly, there remains opportunity for improvement. Furthermore, other desirable features and characteristics of the present disclosure will become apparent from the subsequent detailed description of the disclosure and the appended claims.

### BRIEF SUMMARY

This disclosure provides an emulsion including water; asphalt; an emulsifier in an amount of from about 0.5 to about 5 wt %, based on a total weight of the emulsion; a polyolefin having a weight average molecular weight (M_{w}) of from about 500 to about 30,000 Da; and a copolymer having at least two repeating units wherein a first repeating unit is a styrene residue, and a second repeating unit is a butadiene residue.

This disclosure further provides a method of forming the emulsion including the steps of providing the water; providing the asphalt; providing the emulsifier; providing the polyolefin; providing the copolymer, and combining the water, the asphalt, the emulsifier, the polyolefin and the copolymer to form the emulsion; wherein the emulsifier is present in an amount of from about 0.5 to about 5 wt %, based on a total weight of the emulsion.

Furthermore, this disclosure provides a paving material including the emulsion and an aggregate.

### DETAILED DESCRIPTION

The following detailed description is merely exemplary in nature and is not intended to limit the current composition. Furthermore, there is no intention to be bound by any theory presented in the preceding background or the following detailed description.

Embodiments of the present disclosure are generally directed to polymers, compositions including the same, and methods for forming the same. For the sake of brevity, conventional techniques related to making polymers and such compositions may not be described in detail herein. Moreover, the various tasks and process steps described herein may be incorporated into a more comprehensive procedure or process having additional steps or functionality not described in detail herein. In particular, various steps in the manufacture of polymers and associated compositions are well-known and so, in the interest of brevity, many conventional steps will only be described briefly herein or will be omitted entirely without providing the well-known process details.

In this disclosure, the terminology “about” can describe values±0.1, 0.5, 1, 2, 3, 4, 5, 6, 7, 8, 9, or 10%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

In various embodiments, the terminology “free of” describes embodiments that include less than about 5, 4, 3, 2, 1, 0.5, or 0.1, weight percent of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of polymer molecular weight, e.g., Mn, Mw, Mz, are typically described as average values because the synthesis of polymers typically produces a distribution of various individual molecules.

The polymers and compositions disclosed herein may suitably comprise, consist of, or consist essentially of the components, elements, and process delineations described herein. The embodiments illustratively disclosed herein suitably may be practiced in the absence of any element which is not specifically disclosed herein.

### Emulsion

This disclosure provides an emulsion including water; asphalt; an emulsifier in an amount of from about 0.5 to about 5 wt %, based on a total weight of the emulsion; a polyolefin having a weight average molecular weight (M_{w}) of from about 500 to about 30,000 Da; and a copolymer having at least two repeating units wherein a first repeating unit is a styrene residue, and a second repeating unit is a butadiene residue. The emulsion may be alternatively described as an asphalt emulsion.

The emulsion itself is not particularly limited and may be further defined as an oil-in-water (O/W) emulsion or a water-in-oil (W/O) emulsion. As is well known in the art, O/W emulsions include water as a continuous phase and a non-polar (e.g. oil) compound as a dispersed phase. In O/W emulsions, oil droplets are dispersed throughout a continuous water phase. This means that water surrounds the oil droplets. W/O emulsions include oil as the continuous phase and water as the dispersed phase. In W/O emulsions, water droplets are dispersed throughout a continuous oil phase. Here, oil surrounds the water droplets. In this disclosure, the water can be the continuous phase or the dispersed phase and the combination of the asphalt, polyolefin, copolymer, and/or emulsifier, can be the “oil” or “non-polar” component of the emulsion and be the dispersed phase or the continuous phase.

The type of emulsion is not particularly limited to O/W and W/O emulsions. Additionally, the emulsion may be further defined as a water-in-oil-in-water (W/O/W) emulsion, formed by water droplets present inside oil droplets surrounded by a continuous water phase. Alternatively, the emulsion may be further defined as an oil-in water-in oil (O/W/O) emulsion, formed by oil droplets present inside water droplets surrounded by a continuous oil phase.

Asphalt emulsions are typically categorized based on setting and curing properties, which influence performance and application. Four main types of asphalt emulsions include rapid-setting, quick-setting, medium-setting, and slow-setting emulsions. The emulsion of this disclosure may be any of these types.

Rapid-Setting Asphalt Emulsions (RS) typically break rapidly upon contact with aggregate or when exposed to air. This means the water in the emulsion evaporates rapidly, allowing the asphalt to set and bond with the aggregate quickly. This type of emulsion is typically used for quick repairs and maintenance where immediate trafficability is required. These types of emulsions are suitable for applications where a thin layer is required, such as seal coats or slurry seals. Typically, these types of emulsions break quickly, within minutes, allowing the emulsion to set rapidly. These types of emulsions provide immediate strength, making them effective for areas needing rapid service. These types of emulsions tend to work best in warm and dry conditions, as high humidity can affect the break time.

Quick-Setting Asphalt Emulsions (QS) generally break relatively fast but are slower than rapid-setting emulsions. Once applied, these emulsions can break quickly but still allow for enough time for material distribution and compaction. QS are typically used for slurry seals and micro-surfacing, where materials can be spread and worked with before setting. Typically, these types of emulsions break within minutes to hours, allowing the emulsion to set quickly while allowing some workability. These types of emulsions provide quick strength, making them effective for areas needing fast service. These types of emulsions tend to be used for thin layers, allowing more time for road surface leveling.

Medium-Setting Asphalt Emulsions (MS) offer a balance between rapid and slow-setting emulsions. These types of emulsions break at a moderate rate, making them versatile for various applications. These types of emulsions are suitable for applications requiring a moderate curing time and strength, such as base course stabilization and binder applications. These types of emulsions can be used in road construction and rehabilitation, where a balance between workability and quick setting is needed. These types of emulsions tend to break within a few minutes to hours, depending on environmental conditions and specific formulation. These types of emulsions tend to offer good early strength but allow for additional compaction time compared to rapid-setting emulsions. These types of emulsions are also suitable for a variety of environmental conditions, providing flexibility in project scheduling.

Slow-Setting Asphalt Emulsions (SS) take longer to break and cure. The water in these emulsions evaporates slowly, allowing for extended workability and time for compaction. These types of emulsions are suitable for applications that require strong bonding and durability, such as road base stabilization or thicker surface layers. These types of emulsions are effective in applications requiring a strong bond with aggregates over a longer period, ideal for sealing and surface treatments. These types of emulsions can take several hours to days to break and set, depending on the formulation and environmental factors. These types of emulsions provide strong bonding and durability, making it suitable for heavy traffic areas. These types of emulsions work well in cooler or wetter conditions, as the slower break time allows for better integration with the aggregate.

### Water

The emulsion includes water. The water is not particularly limited and may be purified water, industrial water, tap water, etc. The water is typically fresh water but could be brackish type water. The water is typically present in the emulsion in an amount of from about 20 to about 60, about 25 to about 55, about 30 to about 50, or about 33 to about 50, or about 40 to about 45, weight percent based on a total weight of the emulsion. In various non-limiting embodiments, all values and ranges of values, both whole and fractional, including and between those set forth above are hereby expressly contemplated for use herein.

### Asphalt

The emulsion also includes the asphalt. Asphalt is typically defined by the ASTM D8 as a dark brown to black cementitious material in which the predominant constituents are bitumens that occur in nature or are obtained in petroleum processing. Asphalt characteristically includes saturates, aromatics, resins and asphaltenes. All types of asphalt, e.g. naturally occurring, synthetically manufactured, modified and recovered asphalt, may be used in accordance with the asphalt paving materials contemplated herein. Naturally occurring asphalt is inclusive of native rock asphalt, lake asphalt, and the like. Synthetically manufactured asphalt is often a byproduct of petroleum refining or post refining operations and includes air-blown asphalt, blended asphalt, cracked or residual asphalt, petroleum asphalt, propane asphalt, straight-run asphalt, thermal asphalt, and the like. Modified asphalt includes neat asphalt, e.g. unmodified asphalt that can be naturally occurring or synthetically manufactured, modified with various components. Recovered asphalt includes asphalt from reclaimed asphalt pavement (RAP), recycled asphalt shingle (RAS), recycled roofing, and/or waterproofing membranes.

The asphalt is typically present in the emulsion in an amount of from about 30 to about 79, about 35 to about 75, about 40 to about 70, about 45 to about 65, or about 50 to about 60, weight percent based on a total weight of the emulsion. In various non-limiting embodiments, all values and ranges of values, both whole and fractional, including and between those set forth above are hereby expressly contemplated for use herein.

### Emulsifier

The emulsion also includes the emulsifier. The emulsifier may be used for various purposes, e.g. stabilizing a dispersed phase, customizing breaking and setting of the emulsion, improving the adhesion with the aggregate, etc. The type of emulsifier used can significantly affect the performance of the emulsion. The type of emulsifier used herein is not particularly limited.

In one embodiment, the emulsifier is an anionic emulsifier that has a negative charge. Anionic emulsifiers can be used when aggregates (e.g., crushed stone, gravel) have a positive charge, which is common in siliceous aggregates like quartz or granite. Typical anionic emulsifiers include fatty acids (e.g., oleic acid, tall oil fatty acids), soaps made from these fatty acids, and the like. Anionic emulsions can be used for pavement surface treatments, such as chip seals and slurry seals, where the adhesion of the asphalt to the aggregate is important.

In various embodiments, the anionic emulsifier is or include a tall oil fatty acid, which can be used due to its effectiveness in stabilizing asphalt emulsions and promoting adhesion to aggregates. It can react with a base, such as sodium hydroxide (NaOH) or potassium hydroxide (KOH), to form soap emulsifiers.

The emulsifier can alternatively be or include a rosin acid and can be used to stabilize the emulsion and provide good coating characteristics on aggregates. The emulsifier can also be or include a lignin sulfonate which can be used to reduce the viscosity of the emulsion, improving the coating on the aggregate, and stabilizing the asphalt droplets in the emulsion. The emulsifier can alternatively be or include sodium or potassium oleate which can be used to stabilize the emulsion. The emulsifier can alternatively be or include an alkyl aryl sulfonate.

In other embodiments, the emulsifier is a cationic emulsifier that has a positive charge. Cationic emulsifiers are typically used when the aggregate has a negative charge, which is typical for limestone and other calcareous materials. Typical cationic emulsifiers include quaternary ammonium salts, amine derivatives (e.g., alkylamines, diamines), and the like. Cationic emulsions are widely used in a variety of asphalt applications, including tack coats, cold mixes, and micro-surfacing. They are generally faster to break (set) than anionic emulsions, which can be important in certain applications where quick adhesion is required.

In one embodiment, the emulsifier may be or include a quaternary ammonium salts such as cetyltrimethylammonium chloride (CTAC). In other embodiments, the emulsifier may be or include fatty amines and/or diamines such as octadecylamine (stearylamine), tallow amine, ethylenediamine (EDA), and the like. Alternatively, the emulsifier may be or include an imidazoline such as oleyl imidazoline, coco imidazoline, and the like. Moreover, the emulsifier may be or include an amidoamine such as tall oil amidoamine, coco amidoamine, and the like. The emulsifier may alternatively be or include a polyamine derivative such as polyethylenepolyamine (PEPA), diethylenetriamine (DETA), and the like.

In other embodiments, the emulsifier is a non-ionic emulsifier that does not have a charge. Nonionic emulsifiers can work in a broad range of conditions. In some embodiments, they are used without any other emulsifiers. In other embodiments, they are used in conjunction with anionic or cationic emulsifiers to modify properties of the emulsion. Typical non-ionic emulsifiers include ethoxylated alcohols, sorbitan esters, and the like. Non-ionic emulsifiers can be used in more specialized applications where a neutral charge is beneficial or where emulsions need to be compatible with both types of aggregates.

In various embodiments, the emulsifier may be or include ethoxylated alcohol such as cetostearyl alcohol ethoxylates, lauryl alcohol ethoxylates, and the like. In other embodiments, the emulsifier may be or include a sorbitan ester such as sorbitan monostearate, sorbitan monooleate, and the like. Alternatively, the emulsifier may be or include a polyethylene glycol (PEG) ester such as PEG-40 Stearate, PEG-20 Oleate, and the like. In other embodiments, the emulsifier may be or include an alkylphenol ethoxylates such as nonylphenol ethoxylate, octylphenol ethoxylate, and the like. Further, the emulsifier may be or include a fatty acid ethoxylate such as stearic acid ethoxylate, oleic acid ethoxylate, and the like.

In still other embodiments, the emulsifier is an amphoteric emulsifier that has a charge that can be cither positive or negative depending on the pH of the emulsion. These emulsifiers can be used where flexibility in pH or charge is required.

In various embodiments, the emulsifier may be or include a betaine such as cocamidopropylbetaine, lauryl betaine and the like. In other embodiments, the emulsifier may be or include an aminopropionate such as sodium cocoyl aminopropionate, disodium cocoamphodipropionate, and the like. In other embodiments, the emulsifier may be or include an amphoteric imidazoline such as cocoamphocarboxyglycinate, sodium cocoamphoacetate, and the like. The emulsifier may alternatively be or include an amphoteric sulfonate such as lauryl sulfobetaine, cocamidopropyl hydroxysultaine, and the like. The choice of which emulsifiers to use is related to the nature of the aggregate. Temperature, humidity, and pH of the emulsion and environment can also influence the choice of emulsifier. Fast-setting emulsions often use cationic emulsifiers, while slower-setting ones might use anionic emulsifiers.

The emulsifier is present in the emulsion in an amount of from about 0.5 to about 5 weight percent based on a total weight of the emulsion. In various embodiments, the emulsifier is present in an amount of from about 0.5 to about 5, about 0.5 to about 4.5, about 1 to about 4, about 1.5 to about 3.5, about 2 to about 3, about 2.5 to about 3, about 0.5 to about 1, about 0.6 to about 0.9, or about 0.7 to about 0.8, weigh percent based on a total weight of the emulsion. In various non-limiting embodiments, all values and ranges of values, both whole and fractional, including and between those set forth above are hereby expressly contemplated for use herein.

### Polyolefin

Referring now to the polyolefin, the polyolefin may be further described as a plastomer. The polyolefin may be described using molecular weight, e.g. average weight molecular weight (M_{w}), number average molecular weight (Mₙ), viscosity average molecular weight (Mᵥ), Z-avearge molecular weight (M_{z}), etc. In various embodiments, the polyolefin has weight average molecular weight (M_{w}) of from about 500 to about 30,000 Da. In various other embodiments, the M_{w} is from about 1000 to about 29,000, about 2000 to about 28000, about 3000 to about 27000, about 4000 to about 26000, about 5000 to about 25000, about 6000 to about 24000, about 7000 to about 23000, about 8000 to about 22000, about 9000 to about 21000, about 10000 to about 20000, about 11000 to about 19000, about 12000 to about 18000, about 13000 to about 17000, about 14000 to about 16000, or about 15000 to about 16000, Da. In other embodiments, the M_{w} is from about 500 to about 5000, about 1000 to about 4500, about 1500 to about 4000, about 2000 to about 3500, or about 2500 to about 3000, Da. In yet other embodiments, the M_{w} is from about 1000 to about 10000, about 2000 to about 9000, about 3000 to about 8000, about 4000 to about 7000, about 5000 to about 6000, Da. In various non-limiting embodiments, all values and ranges of values, both whole and fractional, including and between those set forth above are hereby expressly contemplated for use herein.

The polyolefin may be a homopolymer or a copolymer. In an embodiment, the polyolefin is polyethylene. The polyethylene can be a low density polyethylene (e.g. having a density of about 0.91 to about 0.935 g/cc), a linear low density polyethylene (e.g. having a density of about 0.91 to about 0.93 g/cc), a high density polyethylene (e.g. having a density of about 0.94 to about 0.97 g/cc), a medium density polyethylene (e.g. having a density of about 0.925 to about 0.94 g/cc), etc. In one embodiment, the polyolefin is an oxidized polyethylene having a density of from about 0.93 to about 1 g/cc. Suitable polyolefins include Honeywell Titan® polymers, manufactured by Honeywell International Inc., which is headquartered in Charlotte, NC. In other embodiments, the polyolefin has a density of from about 0.85 to about 1.00, about 0.86 to about 0.99, about 0.87 to about 0.98, about 0.88 to about 0.97, about 0.89 to about 0.96, about 0.9 to about 0.95, about 0.91 to about 0.94, or about 0.92 to about 0.93, g/cc. In various embodiments, the density is measured according to ASTM D-1505. In various non-limiting embodiments, all values and ranges of values, both whole and fractional, including and between those set forth above are hereby expressly contemplated for use herein.

In various embodiments, the polyolefin is present in an amount of from about 0.1 to about 5, about 0.5 to about 4.5, about 1 to about 4, about 1.5 to about 3.5, about 2 to about 3, about 2.5 to about 3, about 0.1 to about 1, about 0.2 to about 0.9, about 0.3 to about 0.8, about 0.4 to about 0.7, or about 0.5 to about 0.6, weigh percent based on a total weight of the emulsion. In various non-limiting embodiments, all values and ranges of values, both whole and fractional, including and between those set forth above are hereby expressly contemplated for use herein.

### Copolymer

Referring now to the copolymer, the copolymer may be further described as an elastomer. The copolymer has at least two repeating units wherein a first repeating unit is a styrene residue, and a second repeating unit is a butadiene residue. In one embodiment, the copolymer is or includes a Styrene-Butadiene Rubber (SBR). The SBR is not particularly limited and may be of any type known in the art. Typically, SBR has a random or block arrangement of styrene and butadiene repeating units. In various embodiments, SBR typically includes about 23.5 wt % styrene residues and 76.5 wt % butadiene residues. In various embodiments, the amount of the styrene residue is from about 10 to about 30, about 15 to about 25, about 20 to about 25, weight percent based on a total weight of the SBR. In other embodiments, the amount of the butadiene residue is from about 60 to about 80, about 65 to about 75, or about 75 to about 80, weight percent based on a total weight of the SBR. In various non-limiting embodiments, all values and ranges of values, both whole and fractional, including and between those set forth above are hereby expressly contemplated for use herein.

In other embodiments, the copolymer is or includes a Styrene-Butadiene Block Copolymer (SBS). As is known in the art, SBS is a type of block copolymer with distinct blocks of styrene and butadiene. The SBS typically has a structure where blocks of polystyrene (hard segments) are separated by blocks of polybutadiene (soft segments). SBS is a thermoplastic elastomer, meaning it has both the elastic properties of rubber and the processability of plastics. Typically, in SBS, the styrene content typically is from about 10 to about 40, about 15 to about 35, about 20 to about 30, or about 25 to about 35, weight percent based on a total weight of the SBS. Moreover, the butadiene content is typically the balance. In various non-limiting embodiments, all values and ranges of values, both whole and fractional, including and between those set forth above are hereby expressly contemplated for use herein.

### Physical Properties of the Emulsion

The emulsion is not particularly limited relative to physical properties. For example, the emulsion may exhibit various viscosities. The viscosity can influence the application, handling, and performance of the emulsion. Viscosity for asphalt emulsion is typically measured in second(s) that a 60 mL of the emulsion flow through an orifice, e.g. a calibrated Furol orifice or a calibrated Universal orifice under specified conditions in accordance with AASHTO T72 and varies depending on the type of emulsion (rapid-setting, quick-setting, medium-setting, or slow-setting), temperature, and concentration of the asphalt in the emulsion.

In various embodiments, the emulsion has a viscosity, measured using any of the aforementioned methods, of from about 10 to about 500, about 100 to about 400, or about 200 to about 300, second(s), measured at a temperature of from about 25° C. to about 50° C., e.g. at about 25° C., about 30° C., about 35° C., about 40° C., about 45° C., or about 50° C. In various non-limiting embodiments, all values and ranges of values, both whole and fractional, including and between those set forth above are hereby expressly contemplated for use herein.

In various embodiments, e.g. Rapid-Setting Emulsions, the viscosity is from about 10 to about 500 s, measured at 50° C. in accordance with AASHTO T72. In various embodiments, the viscosity is from about 15 to about 450, about 20 to about 400, about 40 to about 350, about 75 to about 300, about 100 to about 250, or about 150 to about 200 s. In various non-limiting embodiments, all values and ranges of values, both whole and fractional, including and between those set forth above are hereby expressly contemplated for use herein.

In other embodiments, e.g. Quick-Setting Emulsions, the viscosity is from about 10 to about 200 s, measured at 25° C. in accordance with AASHTO T72. In other embodiments, the viscosity is from about 15 to about 150, about 20 to about 100, about 25 to about 75, about 30 to about 60, or about 35 to about 50 s. In various non-limiting embodiments, all values and ranges of values, both whole and fractional, including and between those set forth above are hereby expressly contemplated for use herein.

In other embodiments, e.g. in Medium-Setting Emulsions, the viscosity is from about 10 to about 500 s measured at 50° C. in accordance with AASHTO T72. In various embodiments, this viscosity is from about 25 to about 475, about 50 to about 450, about 75 to about 400, about 100 to about 350, or about 150 to about 300 s. In various non-limiting embodiments, all values and ranges of values, both whole and fractional, including and between those set forth above are hereby expressly contemplated for use herein.

In further embodiments, e.g. Slow-Setting Emulsions, the viscosity is from about 10 to about 200 s, measured at about 25° C. in accordance with AASHTO T72. In other embodiments, the viscosity is from about 15 to about 150, about 20 to about 100, about 25 to about 75, about 30 to about 60, or about 35 to about 50 s. In various non-limiting embodiments, all values and ranges of values, both whole and fractional, including and between those set forth above are hereby expressly contemplated for use herein.

In various embodiments, the asphalt is present in the emulsion as droplets. For example, in O/W emulsions, the oil droplets are not particularly limited relative to their particle size. In various embodiments, the oil droplets may have a Dv10, Dv50, Dv90, Dn10, Dn50, and/or Dn90 particle size each independently as described below, e.g. each independently of from about 0.1 to about 20, about 1 to about 10, or about 2 to about 5, microns. In other embodiments, the Dv90 diameter is from about 0.1 to about 1, about 0.2 to about 0.9, about 0.3 to about 0.8, about 0.4 to about 0.7, or about 0.5 to about 0.6, microns. In yet other embodiments, the Dv90 diameter is from about 1 to about 20, about 2 to about 19, about 3 to about 18, about 4 to about 17, about 5 to about 16, about 6 to about 15, about 7 to about 14, about 8 to about 13, about 9 to about 12, or about 10 to about 11, microns. In various non-limiting embodiments, all values and ranges of values, both whole and fractional, including and between those set forth above are hereby expressly contemplated for use herein.

In various other embodiments, the asphalt is present in the emulsion as droplets. For example, in W/O emulsions, the water droplets are not particularly limited relative to their particle size. In various embodiments, the water droplets may have a Dv10, Dv50, Dv90, Dn10, Dn50, and/or Dn90 particle size each independently as described below, e.g. each independently of from about 0.1 to about 20, about 1 to about 10, or about 2 to about 5, microns. In other embodiments, the Dv90 diameter is from about 0.1 to about 1, about 0.2 to about 0.9, about 0.3 to about 0.8, about 0.4 to about 0.7, or about 0.5 to about 0.6, microns. In yet other embodiments, the Dv90 diameter is from about 1 to about 20, about 2 to about 19, about 3 to about 18, about 4 to about 17, about 5 to about 16, about 6 to about 15, about 7 to about 14, about 8 to about 13, about 9 to about 12, or about 10 to about 11, microns. In various non-limiting embodiments, all values and ranges of values, both whole and fractional, including and between those set forth above are hereby expressly contemplated for use herein.

Particle size may be determined using one or more methods such as ASTM D5861, ISO 13320:2009, ISO 13320:2020, or the like. It is also contemplated that one or more of the Dv10, Dv50, Dv90, Dn10, Dn50, and/or Dn90 particle size measurements may fall outside of the aforementioned ranges. Alternatively, a Dv10, Dv50, Dv90, Dn10, Dn50, and/or Dn90 particle size may be any described above. Moreover, the particle size may be determined using any apparatus known in the art, e.g. a Malvern Mastersizer such as the Mastersizer 3000. Relative to software version, type of light scattering model applied, real and imaginary part of complex refractory index if Mie theory is applied, refractive index, sampling procedure, amount and power of ultrasound, etc. can each be chosen by one of skill in the art if not set forth in the aforementioned standard procedures. In various non-limiting embodiments, all values and ranges of values, both whole and fractional, both between and including each of the above, are hereby expressly contemplated for use herein.

The emulsion may be further described relative to elastic recovery. To measure the clastic recovery, the emulsion may be distilled to form a residue. The residue may be stretch-tested using various tools and/or methods known in the art, e.g. using a ductilometer, using a standardized method, e.g. AASHTO T301, AASHTO PP 72-11, ASTM D7497-09, etc. The elastic recovery can describe the residue's ability to return to its original shape after being deformed by stress or strain. The elastic recovery is often expressed as a percentage of the original deformation.

In various embodiments, the elastic recovery is from about 20 to about 70, about 25 to about 65, about 30 to about 60, about 35 to about 55, or about 35 to about 50, %, as measured in accordance with AASHTO T301. In various non-limiting embodiments, all values and ranges of values, both whole and fractional, both between and including each of the above, are hereby expressly contemplated for use herein.

### Method of Forming the Emulsion:

The emulsion may be form using any method and/or process known in the art. A method of forming an emulsion includes the steps of providing the water; providing the asphalt; providing the emulsifier; providing the polyolefin; providing the copolymer, and combining the water, the asphalt, the emulsifier, the polyolefin and the copolymer to form the emulsion; wherein the emulsifier is present in an amount of from about 0.5 to about 5 wt %, based on a total weight of the emulsion.

The steps of providing the components in the emulsion, e.g. the water, the asphalt, the emulsifier, the polyolefin and the copolymer, may be any known in the art and are not particularly limited. For example, each of the components may be procured from in-house and/or external sources. Additionally, the components may be provided in various physical forms, e.g. as a solid, as a solution, as a liquid, etc.

Referring now to the step of combining, the step may be described as a batch or a continuous process. Additionally, the components may be combined in any order, in a partial or whole amount, and/or in a single or multiple steps.

In various embodiments, the step of combining is further defined as the steps of adding the polyolefin and the copolymer to the asphalt to form a modified asphalt; adding the emulsifier to the water to form an emulsifier solution; and combining the modified asphalt and the emulsifier solution to form the emulsion.

In various other embodiments, the step of combining is further defined as the steps of adding the polyolefin produce a modified asphalt; adding the copolymer to water to form a latex solution; adding the emulsifier to the water to form an emulsifier solution; and combining the modified asphalt, the latex solution, and the emulsifier solution to form emulsion.

In yet other embodiments, the step of combining is further defined as the steps of adding the polyolefin produce a modified asphalt; adding the emulsifier to the water to form an emulsifier solution; combining the modified asphalt and the emulsifier solution to form a pre-emulsion; adding the copolymer to the water to form a latex solution; combining the pre-emulsion and the latex solution to form the emulsion.

### Paving Material

This disclosure also provides a paving material. The paving material includes the emulsion and an aggregate. In the paving material itself, the emulsion may be present in an amount of from about 1 to about 20, about 1 to about 15, about 5 to about 10, or about 1, 2, 3, 4, 5, 6, 7, 8, 9, 10, 11, 12, 13, 14, 15, 16, 17, 18, 19, or 20, weight percent based on a total weight of the paving material. In various non-limiting embodiments, all values and ranges of values, both whole and fractional, both between and including each of the above, are hereby expressly contemplated for use herein.

Referring now to the aggregate itself, the terminology “aggregate” is a collective term for mineral materials, typically in a granulated form, such as, for example, sand, gravel, or crushed stone that are combined with the asphalt binder to form the asphalt paving material. The aggregate may include natural aggregate, manufactured aggregate, or a combination thereof. Natural aggregate is typically extracted rock from an open excavation (e.g. a quarry) that is reduced to usable sizes by mechanical crushing. Manufactured aggregate is typically a byproduct of other manufacturing processes such as slag from metallurgical processing (e.g. steel, tin, and copper production). Manufactured aggregate also includes specialty materials that are produced to have a particular physical characteristic not found in natural rock, such as, for example, low density. The gradation of the aggregates is carefully controlled in a hot mix design to optimize its performance Hot mix designs can be categorized in “dense graded,” Stone Matrix Asphalt (SMA), Open Graded Friction Course (OGFC) and the like based on the relative proportions of the aggregate sized.

The aggregate may be present in an amount of from about 80 to about 99, about 85 to about 95, about 85 to about 90, about 90 to about 99, about 90 to about 95, about 95 to about 99, or about 80, 81, 82, 83, 84, 85, 86, 87, 88, 89, 90, 91, 92, 93, 94, 95, 96, 97, 98, or 99, weight percent based on a total weight of the paving material. In various non-limiting embodiments, all values and ranges of values, both whole and fractional, both between and including each of the above, are hereby expressly contemplated for use herein.

### Additives

The emulsion and/or the paving material may include, or be free of, one or more additives. For example, in cold mix asphalt (CMA), various fillers can be added to improve the performance, workability, and durability of the mixture. These fillers can enhance the physical and chemical properties of the emulsion, contributing to the overall quality of the paving material.

In some embodiments, the additive may be a mineral filler such as hydrated lime, cement, fly ash, calcium carbonate, and the like which may enhance adhesion between the asphalt and aggregate, improve moisture resistance, increase resistance to stripping, help in preventing asphalt binder aging and improves the overall durability of the mix, increase strength and stability of the mix, improve load-bearing capacity, help control moisture-related issues, enhance workability and stability, increase resistance to deformation and cracking, etc.

In other embodiments, the additive may be a recycled material such as recycled asphalt pavement (RAP) which can help reduce costs and environmental impact by reusing existing materials. Alternatively, the additive may be a recycled rubber, a synthetic filler, a fiber such as a cellulose fiber and/or a polypropylene fiber, sand, clay, etc. Even further, the additive may be an ethylene-vinyl acetate (EVA), a silane-based additive, a clay additive such as bentonite, a chemical accelerator, or combinations thereof.

In various embodiments, the paving material may be alternatively described as a Cold Mix Asphalt (CMA) paving material. This type of paving material can be created by combining the emulsion and the aggregate without the need for heating, making it an energy-efficient and environmentally friendly alternative to hot mix asphalt (HMA) paving materials. CMA paving materials are often used for road maintenance, patching, and in areas where hot mix plants are not readily available.

The emulsion and the aggregate can be combined in a central plant (batch plant or continuous mix plant) or directly on-site using a mobile mixing unit or even manually for smaller jobs. Typically, the aggregate is loaded into mixing equipment and is usually dampened slightly to help with the coating process and to reduce dust. The emulsion can then be added to a mixing drum or pugmill which mixes the emulsion and the aggregate until particles of the aggregate are approximately uniformly coated. The mixing time is typically short, usually just a few minutes, but it maximizes thorough and uniform distribution of the emulsion over the aggregate. The mixture is often tested on-site for consistency, coating quality, and workability. Adjustments can be made to the mix, such as adding more emulsion or aggregate to achieve the desired properties. Once mixed, the paving material can be loaded into trucks for transportation to a paving site. At the site, the cold mix can be spread over a prepared roadbed or base layer using a paving machine or by manual labor, depending on the scale and requirements of the project. The layer thickness can vary depending on the type of pavement being constructed (e.g., surface course, base course). The mixture is leveled and initially shaped by the screed of the paver or by hand tools. After the mixture is spread, it can be compacted to remove air voids and ensure a dense, durable pavement. This is typically done with a roller. Once compacted, the emulsion begins to “break,” meaning the water in the emulsion starts to evaporate, and the asphalt coalesces and bonds to the aggregate. The breaking process varies depending on the type of emulsion used wherein rapid-setting emulsions break quickly, while slow-setting emulsions take longer. The mixture is then typically allowed to cure and set. During this period, the pavement gains strength as the water continues to evaporate and the asphalt forms a continuous film that bonds the aggregate together.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. An emulsion comprising:
water;
asphalt;
an emulsifier in an amount of from about 0.5 to about 5 wt %, based on a total weight of the emulsion;
a polyolefin having a weight average molecular weight (M_{w}) of from about 500 to about 30,000 Da; and
a copolymer having at least two repeating units wherein a first repeating unit is a styrene residue, and a second repeating unit is a butadiene residue.

2. The emulsion of claim 1 wherein the copolymer is styrene-butadiene rubber.

3. The emulsion of claim 1 wherein the polyolefin has a weight average molecular weight of from about 1000 to about 10,000 Da.

4. The emulsion of claim 1 wherein the polyolefin has a density of from 0.85 to about 1.00 g/cc, according to ASTM D-1505.

5. The emulsion of claim 1 wherein the polyolefin is a homopolymer.

6. The emulsion of claim 1 wherein the polyolefin is polyethylene.

7. The emulsion of claim 1 wherein the emulsifier is cationic.

8. The emulsion of claim 1 wherein the water is present in an amount of from about 20 to about 60 wt %, based on a total weight of the emulsion.

9. The emulsion of claim 1 wherein the asphalt is present in an amount of from about 30 to about 79 wt %, based on a total weight of the emulsion.

10. The emulsion of claim 1 wherein the emulsifier is present in an amount of from about 0.5 to about 1 wt %, based on a total weight of the emulsion.

11. The emulsion of claim 1 wherein the polyolefin is present in an amount of from about 0.1 to about 5 wt %, based on a total weight of the emulsion.

12. The emulsion of claim 1 wherein the copolymer is present in an amount of from about 0.1 to about 5 wt %, based on a total weight of the emulsion.

13. The emulsion of claim 1 that is an O/W emulsion wherein the asphalt is present as oil droplets and the oil droplets have a Dv90 diameter of from 0.1 to about 20 microns, measured according to ASTM D5861.

14. The emulsion of claim 1 that is a W/O emulsion wherein the water is present as water droplets and the water droplets have a Dv90 diameter of from 0.1 to about 20 microns, measured according to ASTM D5861.

15. The emulsion of claim 1 exhibiting a viscosity of from about 10 to about 500 seconds, measured at a temperature of from about 25° C. to about 50° C., according to AASHTO T72.

16. The emulsion of claim 1 exhibiting an elastic recovery of from about 20 to about 70%, measured according to AASHTO T301.

17. A method of forming an emulsion comprising the steps of
providing water;
providing asphalt;
providing an emulsifier;
providing a polyolefin having a weight average molecular weight (M_{w}) of from about 500 to about 30,000 Da;
providing a copolymer having at least two repeating units wherein a first repeating unit is a styrene residue, and a second repeating unit is a butadiene residue; and
combining the water, the asphalt, the emulsifier, the polyolefin and the copolymer to form the emulsion;
wherein the emulsifier is present in an amount of from about 0.5 to about 5 wt %, based on a total weight of the emulsion.

18. A paving material comprising:
a. an emulsion comprising water, asphalt, an emulsifier in an amount of from about 0.5 to about 5 wt %, based on a total weight of the emulsion, a polyolefin having a weight average molecular weight (M_{w}) of from about 500 to about 30,000 Da, and a copolymer having at least two repeating units wherein a first repeating unit is a styrene residue, and a second repeating unit is a butadiene residue; and
b. an aggregate.

19. The paving material of claim 18 wherein the aggregate is present in an amount of from about 80 to about 99 wt %, based on a total weight of the paving material.

20. The paving material of claim 18 wherein the aggregate is present in an amount of from about 85 to about 90 wt %, based on a total weight of the paving material.
